(19) United States
(12) Patent Application Publication
(10) Pub. No.: US 2026/0235393 A1
(43) Pub. Date: Aug. 13, 2026

(54) LASER STABILIZATION APPARATUS AND METHOD USING HOMODYNE INTERFEROMETER-TYPE OPTICAL REFERENCE MODULE

(71) Applicant: KOREA ADVANCED INSTITUTE OF SCIENCE AND TECHNOLOGY, Daejeon (KR)

(72) Inventors: Jungwon KIM, Daejeon (KR); Igju JEON, Daejeon (KR)

(21) Appl. No.: 19/317,349

(22) Filed: Sep. 3, 2025

(30) Foreign Application Priority Data
Sep. 11, 2024 (KR) 10-2024-0123994
Jul. 24, 2025 (KR) 10-2025-0100332

(51) Int. Cl. G01B 9/02015; G01B 9/02055

(52) U.S. Cl. CPC G01B 9/02028; G01B 9/02069

(57) ABSTRACT

A laser stabilization apparatus comprises an optical reference module configured in a homodyne interferometer type, wherein the optical reference module is configured to: divide output light of a laser into a reference path and a delay path including a delay line; and output an interference signal generated by interference between two optical signals that have passed through the reference path and the delay path; and an optical detecting module configured to detect the interference signal and output an error signal including frequency noise information of the laser.

### CROSS-REFERENCE TO RELATED APPLICATIONS

This application claims priority to and the benefit of Korean Patent Application No. 10-2024-0123994 filed on Sep. 11, 2024, and Korean Patent Application No. 10-2025-0100332 filed on Jul. 24, 2025, the entire contents of which are incorporated herein by reference.

### BACKGROUND

### (a) Field

The present disclosure relates to laser stabilization technology.

### (b) Description of the Related Art

Ultra-stable lasers are essential in many fields that require highly stable frequency references, such as optical lattice clocks, gravitational wave detection, and precision spectroscopy. Additionally, highly stable lasers may be used to generate highly stable microwaves through optical frequency division, which may enhance the performance of a wide range of microwave-photonic applications, including radio astronomy and radar systems. In addition, the demand for smaller, more robust, and portable ultra-stable laser systems continue to grow.

Lasers may be stabilized using optical cavities with high Q factors. Ultra-stable optical cavity-based laser stabilization systems-currently the leading technology in the field-offer excellent performance but are expensive, difficult to set up, and limited to a few laboratories worldwide. In this approach, the distance between two mirrors serves as an optical reference, and several additional devices are employed to minimize mechanical fluctuations. First, the two mirrors must be mounted on ultra-low expansion glass (ULE glass), special coating must be applied to the mirrors, and housed within multiple layers of vacuum chambers and thermal enclosures to suppress environmental disturbances such as ambient noise, heat and mechanical vibration. Therefore, ultra-stable optical cavity-based laser stabilization systems may only be used in well-controlled laboratory environments and are difficult to operate in environments outside the laboratory where heat, vibrations, and noise are present.

Additionally, measuring the frequency difference between the laser and the cavity requires a voltage-controlled oscillator (VCO) and an electro-optical modulator (EOM), which requires a somewhat complexity and technically sophistication to the system.

As such, achieving a high detection slope for frequency-noise measurement while remaining insensitive to laser intensity noise requires a complicated and delicate setup, making packaging and miniaturization difficult. Additionally, since ultra-stable optical cavity-based laser stabilization systems are mainly designed for continuous-wave lasers, stabilizing mode-locked pulsed lasers with multiple-wavelength components usually requires an additional continuous-wave laser.

### SUMMARY

The present disclosure provides a laser stabilization apparatus and method using an optical reference module in the form of a homodyne interferometer.

A laser stabilization apparatus according to some embodiments includes an optical reference module configured in a homodyne interferometer type, the optical reference module being configured to divide output light of a laser into a reference path and a delay path including a delay line; and output an interference signal generated by interference between two optical signals that have passed through the reference path and the delay path; and an optical detecting module configured to detect the interference signal and output an error signal including frequency noise information of the laser.

The optical detecting module may be configured with a balanced optical detector or an optical detector.

The stabilization apparatus may further include a servo system configured to feed the error signal back to a frequency modulator of the laser.

The optical reference module may be configured in a Michelson interferometer type.

The optical reference module may include: a coupler configured to: divide the input light into the reference path and the delay path; and output the interference signal generated by interference between two optical signals that have passed through the reference path and the delay path; the delay line configuring the delay path; a first reflector connected to an end of the reference path; and a second reflector connected to an end of the delay path.

The optical reference module may be configured in a Mach-Zehnder interferometer type.

The optical reference module may include: a first coupler configured to divide the input light into the reference path and the delay path and outputs the divided lights; the delay line configuring the delay path; and a second coupler configured to output the interference signal generated by interference between two optical signals that have passed through the reference path and the delay path.

The delay line may be configured with an optical fiber or optical waveguide.

The laser may be a continuous wave laser.

The laser may be a pulsed laser that outputs an optical frequency comb, and the output light may be a specific frequency component of the optical frequency comb.

A method for operating a laser stabilization apparatus according to some embodiments includes: dividing output light of a laser into a reference path and a delay path including a delay line, and outputting an interference signal generated by interference between two optical signals that have passed through the reference path and the delay path by an optical reference module configured in a homodyne interferometer type; detecting the interference signal and outputting an error signal including frequency noise information of the laser, by an optical detecting module; and feeding the error signal back to a frequency modulator of the laser, by a servo system.

The output light may be a single frequency component extracted from the optical frequency comb of the laser.

The optical reference module may be configured in a Michelson interferometer type or a Mach-Zehnder interferometer type.

The optical detecting module may be configured with a balanced optical detector or an optical detector.

The delay line may be configured with an optical fiber or an optical waveguide.

According to embodiments, by using the homodyne interferometer-type optical reference module, an ultra-stable light source may be generated outside a laboratory environment by carefully arranging a few passive components and packaging the setup against mechanical disturbances such as heat, noise, and vibration.

According to embodiments, the laser stabilization apparatus is implemented with all-optical fiber and alignment-free operation, allowing for application in environments outside the laboratory.

According to embodiments, since there is no restriction on the type of optical fiber required for the laser stabilization apparatus, the optimal optical fiber may be selected based on conditions such as cost and performance, thereby improving the price competitiveness of the laser stabilization apparatus while increasing design flexibility.

According to embodiments, since the laser stabilization apparatus may be configured with only commercially available optical components, it may be implemented at relatively low cost while providing excellent frequency stabilization performance.

According to embodiments, only a few passive optical components are required for frequency stabilization, simplifying the setup and enabling miniaturization and compact packaging due to the reduced volume.

According to embodiments, the optical frequency comb may be directly stabilized by receiving a single component filtered from the optical frequency comb without requiring stabilization through a continuous wave laser.

### BRIEF DESCRIPTION OF THE DRAWINGS

FIG. 1 is a diagram conceptually illustrating a laser stabilization apparatus.

FIGS. 2 to 5 illustrate a laser stabilization apparatus using an optical reference module in the form of a homodyne interferometer according to an embodiment.

FIG. 6 illustrates a laser stabilization apparatus that directly stabilizes an optical frequency comb according to an embodiment.

FIG. 7 is a flowchart illustrating a continuous wave laser stabilization method according to an embodiment.

FIG. 8 is a flowchart illustrating a method for stabilizing an optical frequency comb according to an embodiment.

FIG. 9 shows the results of measuring the frequency noise of a stabilized laser according to an embodiment.

FIG. 10 shows the results of measuring the frequency stability of a stabilized laser according to an embodiment.

### DETAILED DESCRIPTION OF THE EMBODIMENTS

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present disclosure. The drawings and description are to be regarded as illustrative in nature and not restrictive, and like reference numerals designate like elements throughout the specification.

In the description, unless explicitly stated to the contrary, the word “comprise” and variations such as “comprises” and “comprising” should be understood to imply the inclusion of stated elements but not the exclusion of any other elements.

In the description, reference numerals and names are attached for convenience of explanation, and the devices are not necessarily limited to the reference numerals or names.

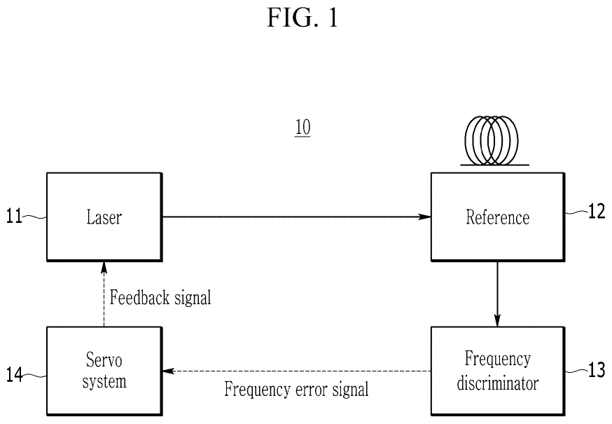

FIG. 1 is a conceptual illustration of a laser stabilization apparatus.

Referring to FIG. 1, since the frequency of a laser 11 may fluctuate due to noise caused by various reasons, a laser stabilization apparatus 10 is employed to suppress frequency noise by stabilizing the laser frequency to a reference.

Generally, laser frequency noise is represented by frequency stability (df/f), which represents frequency fluctuation with respect to carrier frequency. An optical cavity with length stability (dl/l), which represents length fluctuation with respect to optical fiber length, is used as the reference. The performance of an optical reference may be improved by using optical components such as mirrors or optical fibers to compare length information with the laser frequency, and by mechanically designing or arranging the optical components to minimize length fluctuations caused by disturbances.

The laser stabilization apparatus 10 may include a reference 12 for frequency stabilization of the laser 11, a frequency discriminator 13 configured to compare the frequency of the reference 12 and the laser 11 to generate the error signal, and a servo system 14 configured to feedback the error signal to the frequency modulator of the laser 11.

The reference 12 may be configured as an optical cavity that provides length stability of the optical fiber. Since the laser 11 follows the stability of the relatively more stable reference, the frequency stability (df/f) follows the length stability (dl/1) of the relatively more stable optical fiber.

The frequency discriminator 13 may detect a voltage corresponding to the frequency difference between the reference 12 and the laser 11 and output the error signal corresponding to the laser frequency noise. A higher detection slope, i.e., a larger frequency change per unit voltage, enables a higher level of stabilization. Additionally, it is important to ensure that the frequency noise detected by the frequency discriminator 13 is not coupled with other types of laser noise, such as intensity noise.

The servo system 14 feeds the error signal back to the frequency modulator of the laser 11, stabilizing the frequency of the laser 11 according to the length stability of the reference 12.

Various approaches have been conducted to improve laser frequency stabilization performance. Among them, ultra-stable optical cavity-based laser stabilization systems have excellent performance, but their complex setup and high cost limit their applicability. Additionally, determining the frequency difference between the laser and the reference requires additional active components, such as a voltage-controlled oscillator (VCO) and an electro-optic modulator (EOM), making the system more complex and technically demanding. As such, detecting laser frequency noise with a high detection slope while avoiding laser intensity noise involves complexity and sophistication, hindering packaging and miniaturization.

In addition, since the ultra-stable optical cavity-based laser stabilization system is mainly designed for continuous wave lasers (CW lasers), stabilizing mode-locked pulsed lasers with multiple-wavelength components usually requires an additional continuous-wave laser.

The following description presents a laser stabilization apparatus that is relatively inexpensive, has a very simple setup, is alignment-free, and requires no active components such as VCOs or EOMs, allowing for easier packaging and miniaturization compared to ultra-stable optical cavity-based laser stabilization systems.

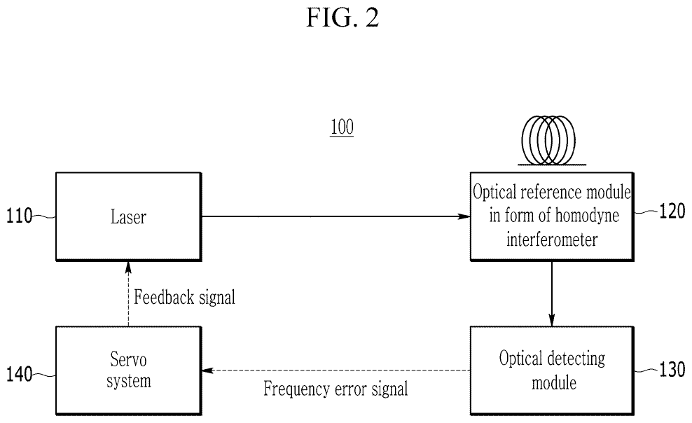

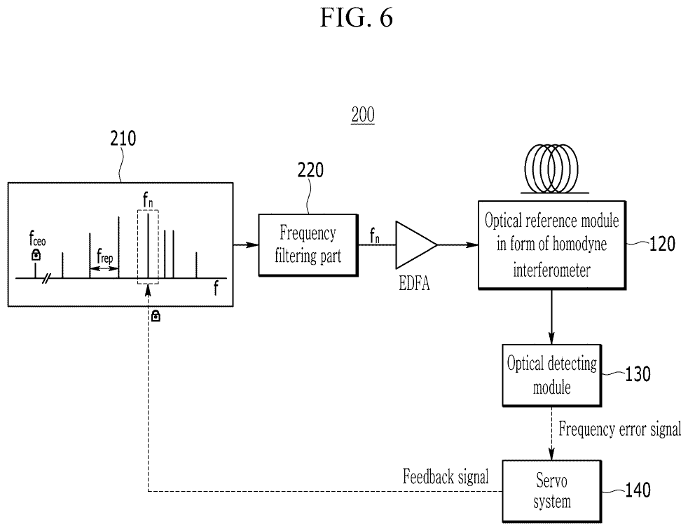

FIGS. 2 to 5 illustrate a laser stabilization apparatus using a homodyne interferometer-type optical reference module according to an embodiment, and FIG. 6 illustrates a laser stabilization apparatus that directly stabilizes an optical frequency comb according to an embodiment.

Referring to FIG. 2, a laser stabilization apparatus 100 that stabilizes the frequency of a laser 110 using an optical reference module 120 configured in a homodyne interferometer type. The laser stabilization apparatus 100 may include the homodyne interferometer-type optical reference module 120, an optical detecting module 130, and a servo system 140. The homodyne interferometer-type optical reference module 120 may be simply referred to as an optical reference module or optical reference.

The optical reference module 120 includes a delay line, which may be configured with an optical fiber or a waveguide. While the description refers to an optical fiber delay line as an example, it is not limited thereto. The homodyne interferometer measures changes in optical intensity caused by interference resulting from the difference in optical paths between a reference path and a delay path including a delay line, without frequency modulation. The homodyne interferometer may be implemented using optical structures such as a Michelson interferometer or a Mach-Zehnder interferometer.

The optical detecting module 130 may detect an interference signal output from the optical reference module 120 and output the error signal corresponding to laser frequency noise. The interference signal arises from the interference of two optical signals that have passed through the reference path and the delay path including the delay line, and includes changes in optical intensity due to differences in the optical path. The optical detecting module 130 may be configured with a balanced optical detector (BPD) to reduce the influence of laser intensity noise on the frequency noise measurement. Alternatively, if the laser intensity noise is lower than the threshold, it may be configured with an optical detector (PD).

The servo system 140 may feedback an error signal to the frequency modulator of the laser 110, thereby stabilizing the frequency of the laser 110. For example, if the error signal is locked to OV through the servo system 140, the laser frequency may be stabilized at a zero-crossing point.

The laser 110 stabilized by the laser stabilization apparatus 100 may be a continuous wave laser (CW laser). In addition, the laser stabilization apparatus 100 may directly stabilize a pulsed laser outputting the optical frequency comb by receiving a single component filtered from an optical frequency comb. This will be described in detail in FIG. 6.

The laser stabilization apparatus 100 may be configured in various ways depending on the combination of the homodyne interferometer type and the optical detection method employed in the optical reference module 120, and this will be exemplified below. In such descriptions, redundant details may be omitted for clarity.

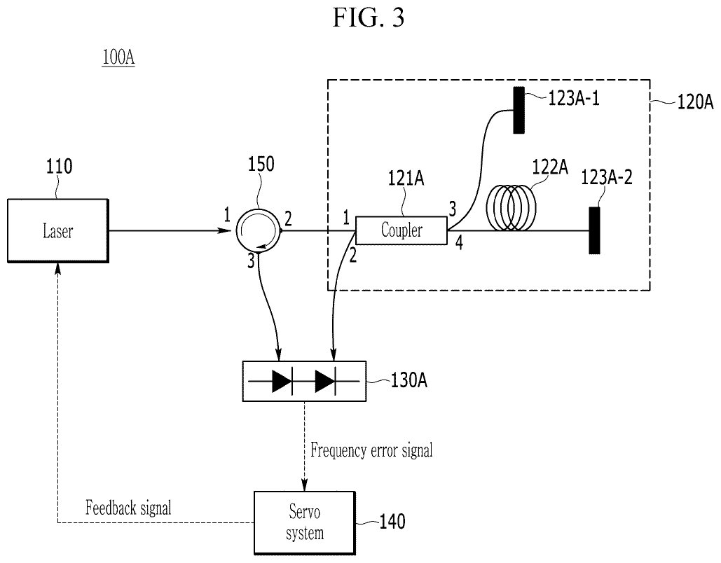

Referring to FIG. 3, a laser stabilization apparatus 100A for stabilizing the frequency of the laser 110 may include an optical reference module 120A configured in a homodyne Michelson interferometer type, an optical detecting module 130A, the servo system 140, and a circulator 150. The optical detecting module 130A may be configured with the balanced optical detector (BPD), and the circulator 150 may be used for this purpose.

The optical reference module 120A may include a coupler 121A that divides or combines input light into the reference path and the delay path, a delay line 122A configuring the delay path, and reflectors 123A-1 and 123A-2 connected to the ends of the reference path and the delay path. The optical path may be configured with a fiber or an optical waveguide.

The coupler 121A may be a 5:5 coupler dividing the input light equally, or may be an unbalanced optical coupler. The delay line 122A may be configured with an optical fiber or an optical waveguide. The reflectors 123A-1 and 123A-2 may be conventional mirrors or Faraday rotating mirrors (FRM). For example, when a single-mode non-polarization-maintaining fiber is used, the reflectors 123A-1 and 123A-2 may be the FRMs. When a polarization-maintaining fiber is used, the reflectors 123A-1 and 123A-2 may be conventional mirrors.

The light emitted from the laser 110 enters port 1 of the circulator 150, exits through port 2, and enters port 1 of the coupler 121A. The coupler 121A divides the light according to the coupling ratio (e.g., 5:5) into the reference path and the delay path including the delay line 122A. The divided lights are reflected by the reflectors 123A-1 and 123A-2 and return to the coupler 121A, where interference occurs.

The interference signal interfered with by the coupler 121A is divided and detected by the optical detecting module 130A. Specifically, the interference signal interfered with in the coupler 121A may be output to ports 1 and port 2, and the interference signal output from port 1 may enter port 2 of the circulator 150 and output to port 3, and then enter first port (e.g., “+” port) of the optical detecting module 130A. The interference signal output from port 2 of the coupler 121A may enter the second port (e.g., “−” port) of the optical detecting module 130A.

The optical detecting module 130A may detect the difference in intensity between two interference signals input to the two photodiodes as a voltage signal, using two photodiodes and a differential amplifier. The optical detecting module 130A may output an error signal including frequency noise information of the laser.

The fluctuations (noise) in the laser frequency and fluctuations in the optical fiber length may be combined in the interference signal. Since the fluctuations in the optical fiber length are much smaller than those in the laser frequency, the detected signal primarily reflects the laser frequency noise. Additionally, the interference signal also includes fluctuations in the laser intensity. Balanced optical detection compensates for the laser intensity noise commonly included in the input lights by measuring the difference of intensity of the input lights. Therefore, the laser intensity noise may be decoupled from the frequency noise. That is, the optical detecting module 130A may prevent laser intensity noise from being coupled to the frequency noise and measured.

The servo system 140 may feed the error signal back to the frequency modulator of the laser 110, thereby stabilizing the frequency of the laser 110.

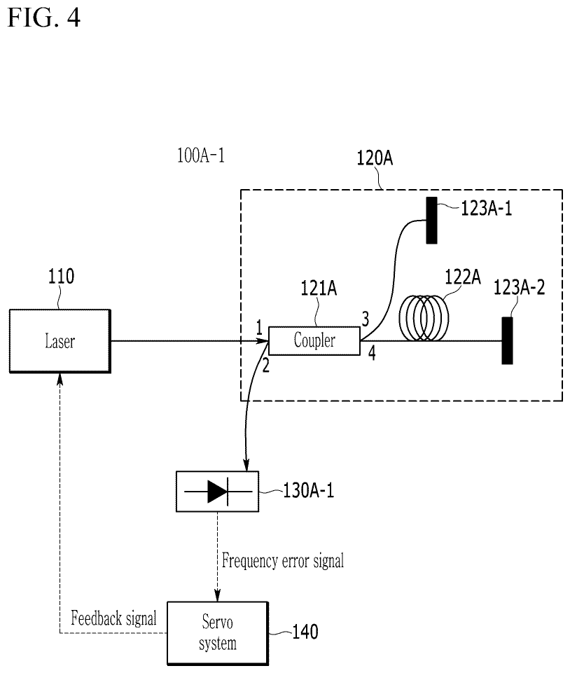

Referring to FIG. 4, a laser stabilization apparatus 100A-1 may include the optical reference module 120A configured in the homodyne Michelson interferometer type, an optical detecting module 130A-1, and the servo system 140. If the laser intensity noise is lower than the threshold, there is no need to compensate for the laser intensity noise through the balanced optical detector, so the interference signal output from the optical reference module 120A may be detected using only the optical detector.

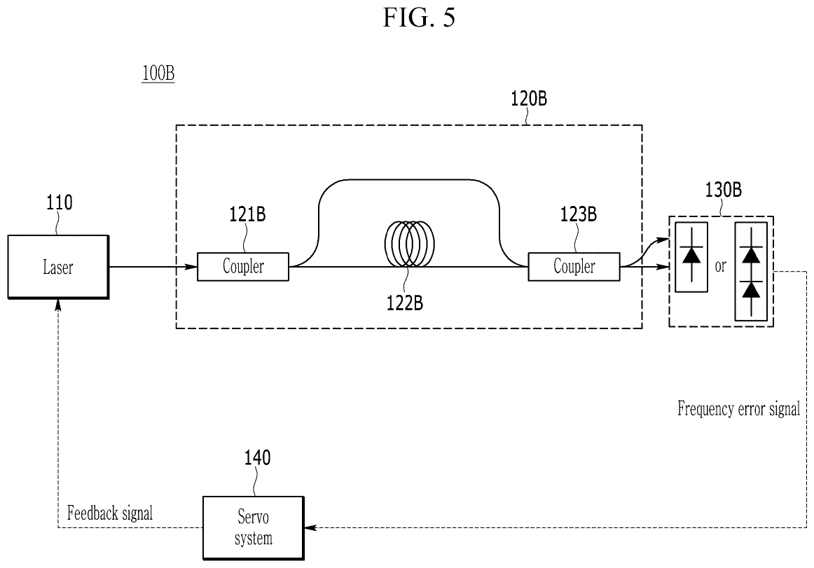

Referring to FIG. 5, a laser stabilization apparatus 100B for stabilizing the frequency of the laser 110 may include an optical reference module 120B configured in a homodyne Mach-Zehnder interferometer type, an optical detecting module 130B, and the servo system 140. The optical detecting module 130B may be configured with the balanced optical detector or the optical detector.

The optical reference module 120B may include a first coupler 121B that divides input light into the reference path and the delay path, the delay line 122A configuring the delay path, and a second coupler 123B that combines two optical signals that have passed through the reference path and the delay path.

The light emitted from the laser 110 is divided by the first coupler 121B into the reference path and the delay path. The two optical signals travel through the reference path and the delay path and enter the second coupler 123B, where interference occurs. The second coupler 123B may divide the interference signal into two output ports.

The optical detecting module 130B may detect an interference signal output from the optical reference module 120B and output an error signal including frequency noise information of the laser. When the second coupler 123B has two output ports, the optical detection module 130B may perform balanced optical detection on the two interference signals to generate the error signal. Alternatively, it may detect interference signal from a single port to generate the error signal.

As such, the laser stabilization apparatus 100 may be implemented with all-optical fiber and is alignment-free, allowing for operation in environments outside the laboratory. When the system that rely on free-space paths between two mirrors, external shocks or vibrations may cause the optical alignment to be misaligned, and the system becomes unstable. By contrast, in the laser stabilization apparatus 100, all components are fiber-coupled, allowing stable operation under vibration or shock environment as long as the fiber integrity is maintained.

There is no limitation on the type of optical fiber required in the laser stabilization apparatus 100. Various optical fibers such as a a single-mode non-polarization maintaining fiber, a polarization maintaining fiber, a photonic crystal fiber, and a low thermal expansion coefficient fiber may be employed.

The laser stabilization apparatus 100 may be constructed using only commercially available optical components, enabling relatively low-cost implementation while providing excellent frequency stabilization performance. It is different from the stabilization system based on the ultra-stable optical reference module, which require special glass or coating for the cavity, and expensive active components such as EOMs.

The laser stabilization apparatus 100 requires only a few passive optical components, simplifying the setup and enabling miniaturization and compact packaging due to the reduced volume. In particular, since the laser stabilization apparatus 100 operates with passive optical components, there is no need to consider an additional heat source, allowing the use of a sealed enclosure made of low-thermal-conductivity materials. In addition, each component is compact, and the optical fiber delay line of several kilometers may be wound on a palm-sized optical fiber spool due to the development of optical gyro sensor manufacturing technology, enabling packaging in a small volume.

Additionally, the laser stabilization apparatus 100 may be configured using an integrable optical waveguide instead of an optical fiber. This enables miniaturization and reduces errors and instabilities associated with optical fiber connections and alignment processes.

Referring to FIG. 6, a laser stabilization apparatus 200 may directly stabilize a pulsed laser 210 that outputs an optical frequency comb. The laser stabilization apparatus 200 may stabilize the frequency of the pulsed laser 210 by stabilizing a single frequency component of the optical frequency comb. The optical frequency comb is represented in the frequency domain as a discontinuous spectrum with a constant frequency interval (fᵣₑₚ). The frequency mode of the optical frequency comb, also referred to as a comb-line mode, is defined by the repetition rate (fᵣₑₚ) and the carrier envelope offset frequency (f_{ceo}). For frequency stabilization, the frequency mode of the optical frequency comb may be mode-locked.

The laser stabilization apparatus 200 may be implemented based on the configuration of the laser stabilization apparatus 100 of FIG. 2, including the the homodyne interferometer-type optical reference module 120, the optical detecting module 130, and the servo system 140. In addition, the laser stabilization apparatus 200 may include a frequency filtering module 220 that extracts a single frequency component (fₙ) from the pulsed laser 210.

The frequency filtering module 220 may be implemented using a combination of a fiber Bragg grating (FBG) and a circulator, or by utilizing a wavelength division multiplexer (WDM) to filter a specific frequency component (fₙ) of an optical frequency comb. The filtered frequency components may be amplified using an erbium-doped fiber amplifier (EDFA) and then incident on the optical reference module 120, such as a continuous wave laser. The optical reference module 120 and the optical detecting module 130 in the laser stabilization apparatus 200 may be varied as described with reference to FIGS. 3 to 5.

In order to stabilize the optical frequency comb using other known laser stabilization techniques, it is necessary to first stabilize the continuous wave laser, and then go through the cumbersome process of stabilizing the optical frequency comb by comparing the stabilized continuous wave laser with the optical frequency comb. In contrast, the laser stabilization apparatus 200 may directly stabilize the optical frequency comb by receiving one component filtered from the optical frequency comb without having to stabilize the optical frequency comb via the continuous wave laser. Therefore, it is possible to make various devices using optical frequency combs regardless of location.

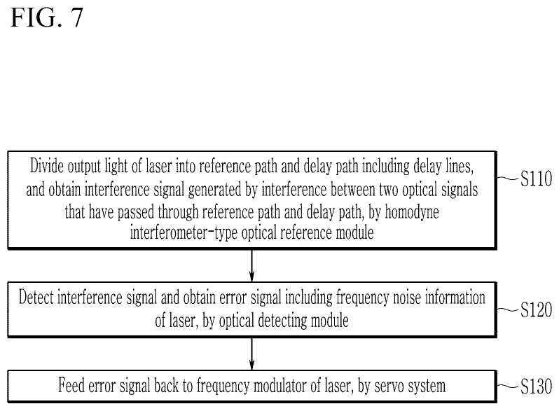

FIG. 7 is a flowchart illustrating a continuous wave laser stabilization method according to an embodiment.

Referring to FIG. 7, the laser stabilization apparatus 100 divides output light of a laser into a reference path and a delay path including a delay line, and obtains an interference signal generated by the interference between two optical signals that have passed through the reference path and the delay path, by a homodyne interferometer-type optical reference module (S110). For example, the homodyne interferometer-type optical reference module may be configured in a Michelson interferometer type or a Mach-Zehnder interferometer type to output the interference signal of two optical signals that have passed through the reference path and the delay path.

The laser stabilization apparatus 100 detects the interference signal and obtains the error signal including frequency noise information of the laser, by the optical detecting module (S120). The optical detecting module may be configured with the balanced optical detector or the optical detector.

The laser stabilization apparatus 100 feeds the error signal back to the frequency modulator of the laser, by the servo system (S130). The frequency of the continuous wave laser may be stabilized to the length stability of the delay line by a error signal feedback.

As such, using the homodyne interferometer-type optical reference module, the laser stabilization apparatus 100 is implemented at relatively low-cost, very simple to set up, alignment-free, and does not require active components such as VCOs or EOMs for frequency modulation, enabling compact packaging and miniaturization. An ultra-stable light source may be generated outside the laboratory environment by appropriately arranging a few passive components and packaging the setup to protect it from mechanical disturbances such as heat, noise, and vibration. For example, since the laser stabilization apparatus 100 may stabilize the laser outside the laboratory, it can be applied to various sensors such as LiDAR system that require ultra-stable lasers to improve resolution, and may be used in precision defense applications such as radar and GPS that require ultra-stable microwave signals to improve positioning accuracy.

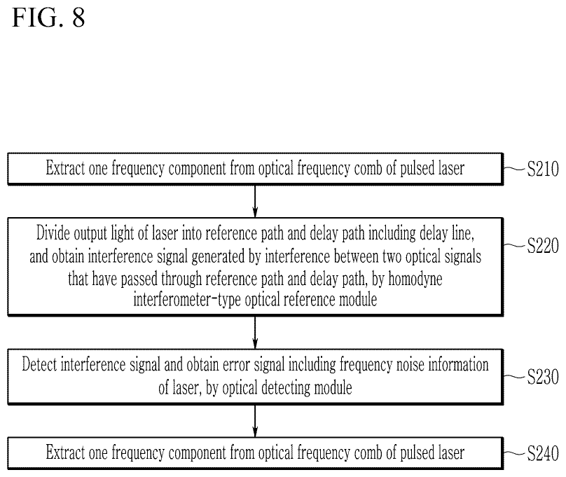

FIG. 8 is a flowchart illustrating a method for stabilizing an optical frequency comb according to an embodiment.

Referring to FIG. 8, the laser stabilization apparatus 200 extracts one frequency component from the optical frequency comb of the pulsed laser (S210). One frequency component of the optical frequency comb may be filtered by combining the fiber Bragg grating (FBG) and the circulator, or may be filtered by utilizing the wavelength division multiplexer (WDM) or the like.

The laser stabilization apparatus 200 divides output light of the laser into a reference path and a delay path including a delay line, and obtains an interference signal generated by the interference between the two optical signals that have passed through the reference path and the delay path, by a homodyne interferometer-type optical reference module (S220). For example, the homodyne interferometer-type optical reference module may be configured in a Michelson interferometer type or a Mach-Zehnder interferometer type to output the interference signal of two optical signals that have passed through the reference path and the delay path.

The laser stabilization apparatus 200 detects the interference signal and obtains the error signal including frequency noise information of the laser, by the optical detecting module (S230). The optical detecting module may be configured with the balanced optical detector or the optical detector.

The laser stabilization apparatus 200 feeds the error signal back to the frequency modulator of the pulsed laser, by the servo system (S240). The frequency components of the optical frequency comb may be stabilized to the reference by the error signal feedback.

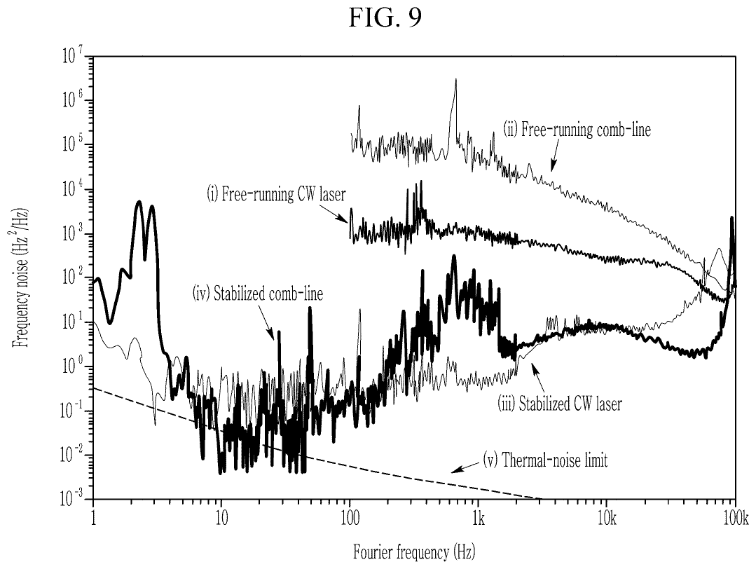

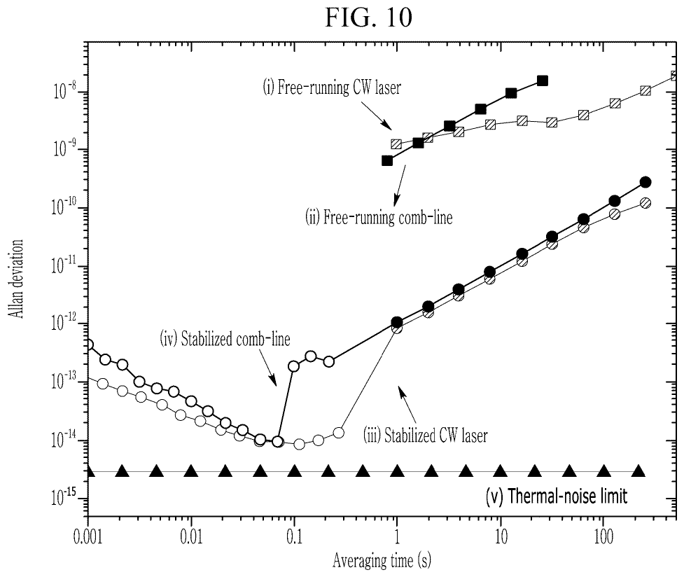

FIG. 9 shows the results of measuring the frequency noise of a stabilized laser according to an embodiment, and FIG. 10 shows the results of measuring the frequency stability of a stabilized laser according to an embodiment.

FIGS. 9 and 10 show the results of comparing the frequency components of a free-running continuous wave laser (i free-running CW laser)/free-running optical frequency comb (ii free-running comb-line) and the frequency components of a continuous wave laser (iii stabilized CW laser)/optical frequency comb (iv stabilized comb-line) stabilized by the present disclosure. Frequency noise was measured by stabilizing the light source with one frequency stabilization setup and another frequency discriminator. Allan deviation, which represents frequency stability, was measured by stabilizing the light source, stabilizing a separate independent continuous wave laser, beating the two lasers, and then counting the beat frequency.

Referring to FIG. 9, when comparing the free-running continuous wave laser (i free-running CW laser) and the continuous wave laser stabilized by the present disclosure (iii stabilized CW laser), the frequency noise at the level of 10³ (Hz²/Hz) was suppressed by more than 1,000 times.

Comparing the frequency components of the free-running optical frequency comb (ii free-running comb-line) and the frequency components of the optical frequency comb stabilized by the present disclosure (iv stabilized comb-line), the frequency noise at the level of 10⁵ (Hz²/Hz) was suppressed by about 100,000 times.

Referring to FIG. 10, the frequency stability was measured by counting the beat frequency, and the continuous wave laser showed a frequency stability of 9.8×10⁻¹⁵ at 80 ms, and the optical frequency comb showed a frequency stability of 9.24×10⁻¹⁵ at 60 ms. This performance is equivalent to the level of 10⁻¹⁵ frequency stability that may be achieved in a laboratory environment with ultra-stable optical cavity-based stabilization technology, a world-leading technology.

The embodiments of the present disclosure described above are not implemented only through devices and methods, but may also be implemented through a program that realizes a function corresponding to the configuration of the embodiments of the present disclosure or a recording medium on which the program is recorded.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A laser stabilization apparatus, comprising:
an optical reference module configured in a homodyne interferometer type, the optical reference module being configured to divide output light of a laser into a reference path and a delay path including a delay line; and output an interference signal generated by interference between two optical signals that have passed through the reference path and the delay path; and
an optical detecting module configured to detect the interference signal and output an error signal including frequency noise information of the laser.

2. The laser stabilization apparatus of claim 1, wherein the optical detecting module is configured with a balanced optical detector or an optical detector.

3. The laser stabilization apparatus of claim 1, further comprising
a servo system configured to feed the error signal back to a frequency modulator of the laser.

4. The laser stabilization apparatus of claim 1, wherein the optical reference module is configured in a Michelson interferometer type.

5. The laser stabilization apparatus of claim 4, wherein the optical reference module comprises:
a coupler configured to: divide the input light into the reference path and the delay path; and output the interference signal generated by interference between two optical signals that have passed through the reference path and the delay path;
the delay line configuring the delay path;
a first reflector connected to an end of the reference path; and
a second reflector connected to an end of the delay path.

6. The laser stabilization apparatus of claim 1, wherein the optical reference module is configured in a Mach-Zehnder interferometer type.

7. The laser stabilization apparatus of claim 6, wherein the optical reference module comprises:
a first coupler configured to divide the input light into the reference path and the delay path and outputs the divided lights;
the delay line configuring the delay path; and
a second coupler configured to output the interference signal generated by interference between two optical signals that have passed through the reference path and the delay path.

8. The laser stabilization apparatus of claim 1, wherein the delay line is configured with an optical fiber or optical waveguide.

9. The laser stabilization apparatus of claim 1, wherein the laser is a continuous wave laser.

10. The laser stabilization apparatus of claim 1, wherein the laser is a pulsed laser that outputs an optical frequency comb, and the output light is a specific frequency component of the optical frequency comb.

11. A method for operating a laser stabilization apparatus, comprising:
dividing output light of a laser into a reference path and a delay path including a delay line, and outputting an interference signal generated by interference between two optical signals that have passed through the reference path and the delay path by an optical reference module configured in a homodyne interferometer type;
detecting the interference signal and outputting an error signal including frequency noise information of the laser, by an optical detecting module; and
feeding the error signal back to a frequency modulator of the laser, by a servo system.

12. The method of claim 11, wherein the output light is a single frequency component extracted from the optical frequency comb of the laser.

13. The method of claim 11, wherein the optical reference module is configured in a Michelson interferometer type or a Mach-Zehnder interferometer type.

14. The method of claim 11, wherein the optical detecting module is configured with a balanced optical detector or an optical detector.

15. The method of claim 11, wherein the delay line is configured with an optical fiber or an optical waveguide.
